(19) United States
(12) Patent Application Publication
(10) Pub. No.: US 2025/0037192 A1
(43) Pub. Date: Jan. 30, 2025

(54) VIRTUAL TRY ON FOR GARMENTS

(71) Applicant: Meta Platforms Technologies, LLC, Menlo Park, CA (US)

(72) Inventors: Moran Vatelmacher, Hod Hasharon (IL); Yigal Reuven Shenkman, Ramat HaSharon (IL); Bat El Shlomo, Ra'anana (IL)

(21) Appl. No.: 18/783,976

(22) Filed: Jul. 25, 2024

Related U.S. Application Data
(60) Provisional application No. 63/515,951, filed on Jul. 27, 2023.

(51) Int. Cl. G06Q 30/0601; G06T 7/11; G06T 7/70; G06T 11/60; G06T 17/00

(52) U.S. Cl. CPC G06Q 30/0643; G06T 7/11; G06T 7/70; G06T 11/60; G06T 17/00

(57) ABSTRACT

Various aspects of the subject technology relate to systems, methods, and machine-readable media for garment virtual try-ons. This may be used, for example, in online shopping or other virtual try-on applications. Various aspects may include receiving an input image of a consumer and a selection for a target garment for try-on. Aspects may also include generating a three-dimensional (3D) body model of the consumer. Aspects may also include generating a masked image by masking a garment from the input image and segmenting the 3D body model of the consumer to fit the masked image and a 3D garment model. Aspects may also include draping the 3D body model of the consumer with the target garment and providing, to the client device, a two-dimensional (2D) rendering of the consumer in the target garment.

### CROSS-REFERENCE TO RELATED APPLICATIONS

The present disclosure is related and claims priority under 35 U.S.C. § 119(e), to U.S. Provisional Patent Application No. 63/515,951, entitled VIRTUAL TRY-ON STRATEGY FOR GARMENT BASED ON 3D PHYSICS SIMULATION, to Moran Vatelmacher et al., filed on Jul. 27, 2023, the contents of which are hereby incorporated by reference in their entirety, for all purposes.

### TECHNICAL FIELD

The present disclosure is directed to virtual try-on (VTO) of garment for online shoppers. More specifically, the present disclosure is directed to generating two-dimensional views of a consumer wearing one or more pieces of garment selected from a three-dimensional digital resource, with realistic physical attributes.

### BACKGROUND

Online shoppers have no choice but to select garments blindly, trusting issues of size and fit based on similar types of clothing they had purchased in the past. This typically leads to errors and item returns, which is a costly proposition for the garment/apparel industry in terms of re-stocking and handling inventory, and a highly frustrating experience for the online shopper.

### BRIEF SUMMARY

The subject disclosure provides for systems and methods for virtual garment try-ons for online shoppers via, for example, a VTO application. According to embodiments, a computer-implemented method for garment virtual try-on is provided. The method includes receiving, at a client device, an input image of a consumer. The method also includes generating a 3D body model of the consumer. The method also includes receiving a selection, from the consumer, of a target garment. The method also includes generating a masked image by masking a first garment from the input image. The method also includes segmenting the 3D body model of the consumer to fit the masked image and a 3D garment model of the target garment. The method also includes draping the 3D body model of the consumer with the target garment. The method also includes providing, to the client device, a try-on image of the consumer including the target garment.

According to embodiments, a system is provided including a processor and a memory comprising instructions stored thereon, which when executed by the processor, cause the processor to perform a method for virtual garment try-ons. The method includes receiving, at a client device, an input image of a consumer. The method also includes generating a 3D body model of the consumer. The method also includes receiving a selection, from the consumer, of a target garment. The method also includes generating a masked image by masking a first garment from the input image having a position corresponding to an intended position of the target garment based on a 3D garment model of the target garment. The method also includes segmenting the 3D body model of the consumer to fit the masked image and the 3D garment model of the target garment. The method also includes draping the 3D body model of the consumer with the target garment. The method also includes providing, to the client device, a try-on image of the consumer including the target garment.

According to embodiments, a non-transitory computer-readable storage medium is provided including instructions (e.g., stored sequences of instructions) that, when executed by a processor, cause the processor to perform a method for generating 2D renderings in a virtual try-on application. The method includes receiving, at a client device, an input image of a consumer. The method also includes generating a 3D body model of the consumer. The method also includes receiving a selection, from the consumer, of a target garment. The method also includes generating a masked image by masking a first garment from the input image having a position corresponding to an intended position of the target garment based on a 3D garment model of the target garment. The method also includes segmenting the 3D body model of the consumer to fit the masked image and the 3D garment model of the target garment. The method also includes draping the 3D body model of the consumer with the target garment. The method also includes providing, to the client device, a try-on image of the consumer in the target garment.

These and other embodiments will become clear to one of ordinary skill in the art, in view of the following.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a block diagram of a device operating environment with which aspects of the present disclosure can be implemented.

FIG. 2 is a block diagram illustrating an overview of a process performed in a virtual try-on application, according to certain aspects of the present disclosure.

FIGS. 3A-3B illustrate examples of images input by consumers and generated by the VTO application, according to certain aspects of the present disclosure.

FIG. 4 is a block diagram illustrating a schematic of a process in a virtual try-on system, according to certain aspects of the present disclosure.

FIG. 5 is an example of images generated according to the virtual try-on system described in FIG. 4, according to certain aspects of the present disclosure.

FIG. 6 illustrates a method for providing an accurate 2D image of a 3D model in a target garment and fit to a consumer, according to certain aspects of the present disclosure.

FIG. 7 illustrates a method for training a virtual try-on model, according to certain aspects of the present disclosure.

FIG. 8 is a block diagram illustrating an example computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

### General Overview

Two-dimensional (2D) virtual try-on (VTO) attempts to leverage three-dimensional (3D) information with body shape reconstruction based on a single image and doing naive 3D garment reconstruction and warping. However, these 2D results only provide stylistic insights to the consumer, and lack a true sense for fit, which is the critical attribute for purchases and helps reduce returns.

Embodiments as disclosed herein provide a solution to the above-mentioned problems arising in the field of online shopping, by providing a VTO experience that incorporates 3D modeling of the garment and the consumer. A VTO model, according to embodiments, may generate a visual representation of the consumer wearing the garment with a fit that is accurate to the consumer, demonstrating how the garment would actually look on the consumer. Accordingly, a realistic, physical fit can be provided for the consumer with a selected online garment while only requiring from the consumer to input an image of the consumer (e.g., a self-portrait or full body picture). The consumer may be wearing any clothes in the input image. The input image serves as a reference for how the final rendering of an image or 3D model should look.

According to some embodiments, consumers may input their own tailor measurements, or visual inputs, to get an accurate 3D body representation. The 3D body representation (or 3D model) may be warped based on the input image of the consumer. Therefore, the 3D body representation may look the same as the consumer. A 3D model of a target garment selected by the consumer is incorporated with the 3D body representation of the consumer and a physics simulation is used to get an accurate fit to the consumer's body. In some embodiments, the 3D model of the garment may include physical parameters such as fabric material, weight or density, strength and the like, and can be retrieved from a database or other online resource associated with a retailer store or brand. According to embodiments, a draped 3D model of the consumer wearing the target garment may be projected onto a 2D space, and refined to get an accurate 2D virtual try-on for consumer appreciation. This can, for example, enable online consumers to wear garments in the virtual world before purchasing.

In some embodiments, the consumer may provide a self-portrait with a specific pose or attitude, to further test a physical feature of the garment (e.g., stretchability, adherence to the body, fluttering, and the like).

According to embodiments, the VTO model may be an algorithm using a pre-existing 3D, full body representation (e.g., a 3D model or 3D mesh) of the consumer and a previously ingested 3D representation of a selected garment, piece of clothing, or the like that the consumer wants to try on to create a VTO experience. The garment representation includes properties of the garment including, but not limited to, physical properties of fabric, strength, density, texture, or the like. The consumer takes one or more pictures or videos (e.g., with a mobile device). The picture or video may be for a selected posture, at a selected angle or point of view (e.g., frontal, back, side, angle, wearing any clothes), etc., from which the consumer would like to visualize themselves with a selected garment. The VTO model takes the image(s) of the consumer as input and combines the 3D full body representation, the 3D garment representation, and the 2D image(s), and generates a realistic, 2D view of the consumer wearing the target garment in the selected pose.

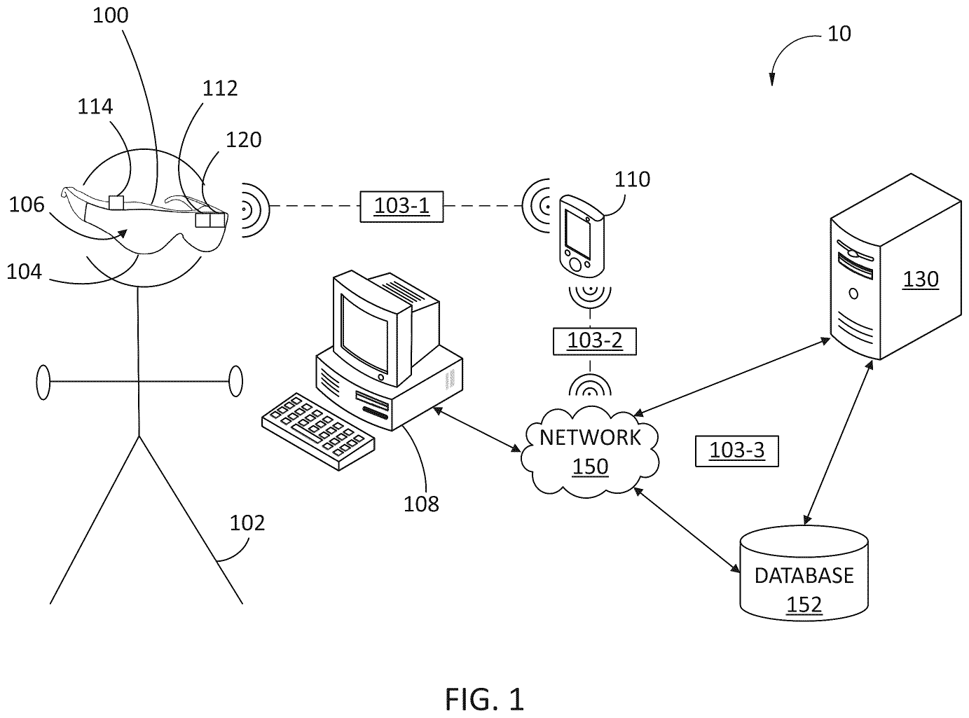

FIG. 1 illustrates an architecture 10 including one or more wearable device 100 (e.g., a VR headset, a mobile phone, or a desktop computer) in a VTO application, according to some embodiments. The wearable device 100 is coupled to a mobile device 110, a remote server 130, and to a database 152. The wearable device 100 may be coupled to one or more client devices, such as desktop computer 108. The wearable device 100 may be configured for mixed, virtual, and/or augmented reality applications, and mobile device 110 may be a smart phone, all of which may communicate with one another via wireless communications and exchange datasets 103-1. The datasets 103-1 may include one or more captured images, recorded videos, audio, or some other file or streaming media.

In some embodiments, the wearable device 100 may directly communicate with the remote server 130, the database 152, or any other client device (e.g., a smart phone of a different user, and the like) via the network. The mobile device may be communicatively coupled with a remote server and a database via a network 150, and transmit/share information, files, and the like with one another, e.g., datasets 103-1, datasets 103-2 and dataset 103-3 (hereinafter, collectively referred to as “datasets 103”). Network 150 may include, for example, any one or more of a local area network (LAN), a wide area network (WAN), the Internet, and the like. Further, the network can include, but is not limited to, any one or more of the following network topologies, including a bus network, a star network, a ring network, a mesh network, a star-bus network, tree or hierarchical network, and the like.

A user 102 of wearable device 100 may be the owner or be associated with mobile device 110 and desktop computer 108. The user 102 may collect, with the mobile device 110, a self-image wearing random clothes. By non-limiting example, the user 102 may input an image of the user 102 to a VTO application and select a garment from an online store or selection options provided via the online store with the wearable device 100, the mobile device 110, a desktop computer 108, or the like. The mobile device 110 may provide the user's self-image (e.g., dataset 103-2) to the remote server 130.

In some embodiments, the wearable device 100 may run an immersive application including a virtual visit to a retail store, boutique, or any apparel store, where a consumer (e.g., a user of the VR headset) may scan or capture an image of themselves and select a target garment to try on, for example, prior to purchase. By non-limiting example, the user 102 may log into a store web page via the desktop computer 108, or store application using the mobile device 110, browse the stock, and select an item for try-on. By non-limiting example (e.g., user via a VR headset or user with mobile device), the VTO application or store application may have access to a body representation such as an avatar of the user and a 3D model of the target garment. The body representation may be a full, 3D model of a body of the user 102. In some implementations, the full body representation is a 3D mesh generated based on one or more 2D images of the user 102. The 3D model of the target garment may include physical attributes such as a weight or density, material or fabric, and physical properties thereof such as stretchability, strength, young modulus, and other properties of the target garment that are relevant to a fit and look upon wear on the user's body.

In some embodiments, the database 152 may include a pre-existing or previously generated 3D representation of the user 102 which is retrieved (e.g., dataset 103-3). In some embodiments, dataset 103-3 may include a 3D representation of the garment selected by the user 102 to try on. The remote server 130 may be configured to combine the self-image of the user 102 and the 3D representation of the target garment to dress the user's avatar with the garment. The remote server 130 may then provide a dressed digital representation (e.g., an avatar) as a 3D model of the user 102 to an immersive application with the wearable device 100 for rendering. With the immersive application, the user may be able to inspect the fitting of the garment under many angles of view. In some embodiments, a 2D image of a dressed avatar is generated and sent to a VTO application running in the wearable device 100, the mobile device 110, or any other client device associated with the user 102. Accordingly, in some embodiments, the user 102 does not need to be wearing the wearable device 100 to enjoy a 2D projection of an accurate and realistic 3D model of themselves wearing a selected garment.

According to some embodiments, the wearable device 100 may include a frame 104 that supports eyepieces, at least one of which includes a VR display 106. Wearable device 100 may include a memory circuit 120 storing instructions, and a processor circuit 112 configured to execute the instructions to cause the wearable device 100 to perform methods and processes as disclosed herein. By non-limiting example, the memory circuit 120 includes the immersive application hosted by the remote server 130, coupled to the database 152 via network 150. The wearable device 100 may include a communications module 114 to communicate wirelessly with the mobile device 110 via a short-range communication (e.g., datasets 103-1, with Bluetooth, low energy—BLE—, Wi-Fi, near field communication—NFC—and the like) or with the remote server or database, via the network (e.g., datasets 103-2 and 103-3). Accordingly, the wearable device 100 may exchange datasets 103-1 with the mobile device 110, which may in turn communicate with the remote server 130 and the database 152. The mobile device 110 may include a display having a two-dimensional pixel array, configured to provide two-dimensional images to the user (e.g., an accurate and fit representation of the user wearing a target garment).

In some embodiments, wearable device 100 may include multiple sensors such as IMUs, gyroscopes, microphones, and capacitive sensors configured as touch interfaces for the user. Other touch sensors may include a pressure sensor, a thermometer, and the like.

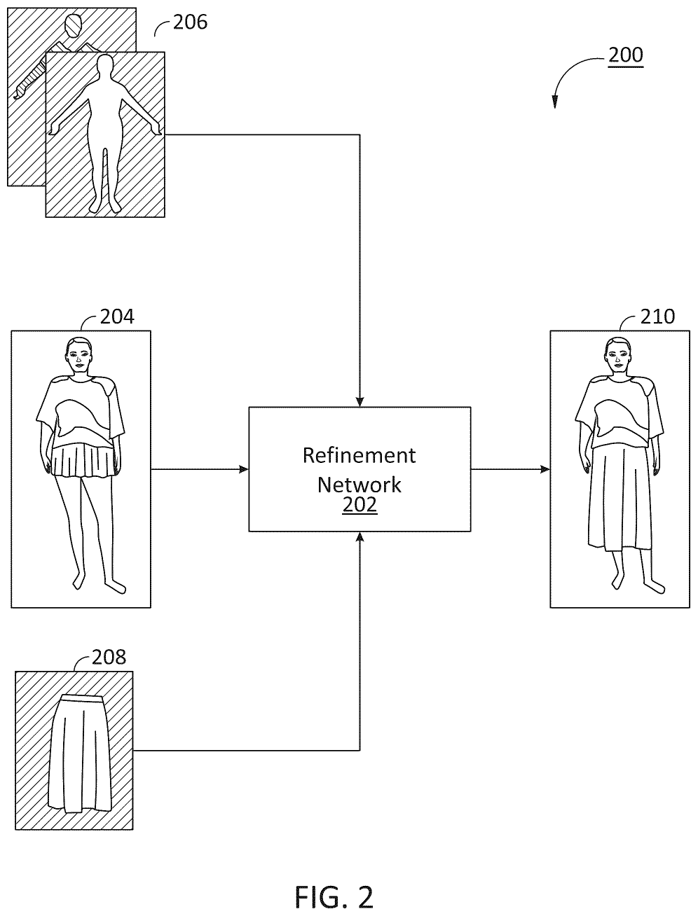

FIG. 2 illustrates an overview of a process performed in a VTO application 200 including a refinement network for providing an accurate 2D visualization in a 3D VTO, according to some embodiments. The VTO application 200 may be based on a refinement network 202 configured to leverage a 3D model of a body, an image of a consumer, and a 3D model of a garment to create a realistic visualization of the consumer wearing the garment. As shown in FIG. 2, the refinement network 202 receives a consumer image 204, metadata 206, and a target garment 208 as input.

The consumer image 204 may be a real, 2D image of a consumer uploaded by the consumer to the VTO application. The consumer may be wearing any garment, making any desired pose or action in the image 204. In some embodiments, the image 204 is a video of the consumer. By non-limiting example, the consumer image 204 is a self-portrait collected by the consumer with a mobile device, VR device, or the like.

The metadata 206 may include a full body mesh, segmentation maps, body shape and pose analysis, structural information about a 3D body, or the like. In some implementations, the metadata 206 may be extracted from one or more sources and used to enhance the structural and visual integrity of the final output. In some implementations, at least some of the metadata 206 is extracted from the 3D bodies. In some implementations, at least some of the metadata 206 is extracted from the consumer image 204. By non-limiting example, the metadata 206 may include angle information describing a position of garments (e.g., location of upper and lower garments) detected in the image 204 and/or the consumer's limbs (e.g., location of a head, arms, and legs of the consumer), a pose identified in the image 204, or the like.

The target garment 208 is a 3D model of a consumer selected garment. By non-limiting example, the selected garment may be an article of clothing (e.g., a skirt, shirt, hat, etc.) the consumer wants to try on to see how it would fit prior to a potential purchase. The target garment 208 includes properties of the garment including, but not limited to, texture, material, size, density, stretchability, strength, etc. The properties enable the refinement network 202 to implement a fit of the selected garment in a 3D model of the consumer including, for example, areas of the garment that may be tight, loose, or have a comfortable fit.

In some embodiments, the refinement network 202 generates a 3D model of the consumer based on the consumer image 204 and determines a fit of the target garment 208. The 3D model of the consumer may be a full body representation of the consumer. The target garment 208 is then warped on the 3D model such that the garment appears fit for the consumer. The refinement network 202 applies metadata 206 by, for example, identifying segmentation maps to separate body parts from clothing, body shape and pose in the consumer image 204, and drape the 3D model of the consumer with the target garment 208. The refinement network 202 outputs a personalized 2D visualization 210 of a 3D virtual try-on of the selected garment that is fit to a shape of the consumer based on the consumer image 204.

According to some embodiments, the refinement network 202 is configured to identify existing clothing in the consumer image 204 and replace a garment, comprising properties corresponding to the target garment 208, in the consumer image 204 with the target garment 208.

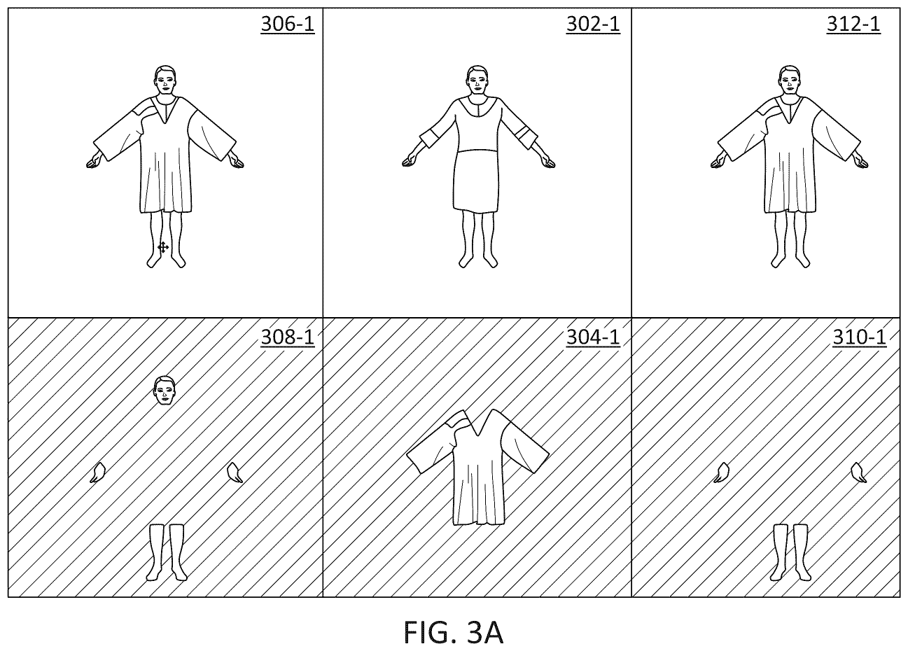

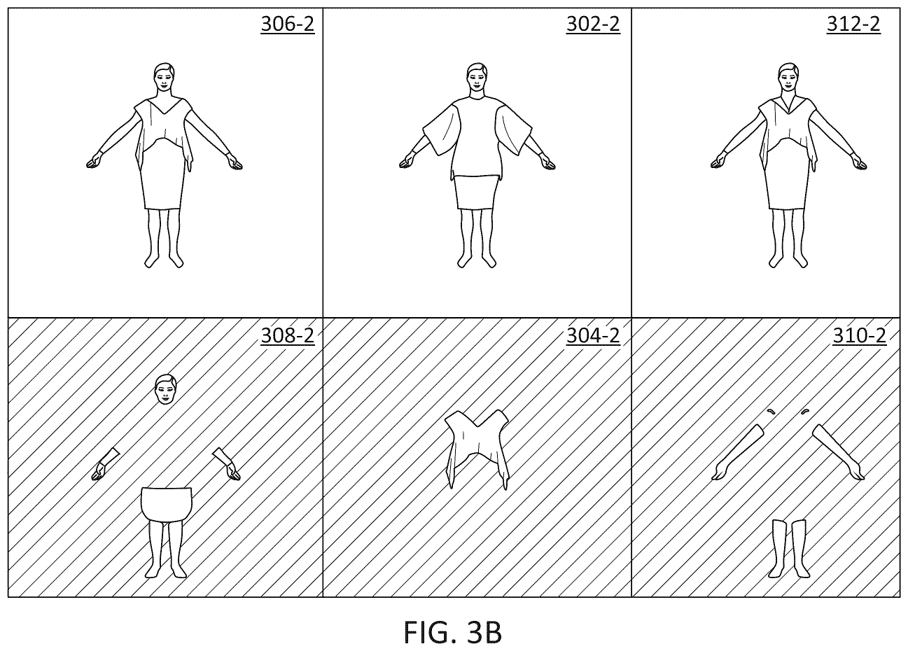

FIGS. 3A-3B illustrate examples of images input by consumers and generated by the VTO application 200, according to some embodiments. By non-limiting example, a consumer may input image 302-1 and image 302-2 (hereafter collectively referred to as “image 302”). The image 302 may be currently captured at a client device, uploaded to a client device, or the like. As shown in FIGS. 3A-3B, the image 302 is a full body image of the consumer. The consumer may select a target garment to try on. The refinement network 202 outputs a prediction image 306-1 and 306-2 (hereafter collectively referred to as “prediction image 306”) of the consumer wearing the target garment (i.e., a visualization of what the consumer would look like wearing the target garment). The prediction image 306 may be a 2D image projected from a 3D model (e.g., an avatar) draped with the target garment.

According to embodiments, segmentation operations are performed on the 3D model to improve the accuracy of the output. In some embodiments, a piece of garment from the original clothes in the input image 302 which corresponds to the target garment (e.g., that will be replaced with the target garment) is identified. The piece of garment is removed from the image 302, as shown in segmented image 308-1 and 308-2 (hereafter collectively referred to as “segmented image 308”), preserving at least a portion of the original clothing and body portions of the consumer. In some embodiments, a position of the clothing and body of the consumer in image 302 is removed based on attributes of the target garment. By non-limiting example, segmented image 308-2 preserves more of the image 302-2 compared to segmented image 308-1 due to properties (e.g., difference in size) of the selected garment differing in each of the examples of FIGS. 3A-3B.

According to embodiments, draped target garment 304-1 and 304-2 (hereafter collectively referred to as “draped target garment 304”) is generated in a draping stage that brings in a projection of the 3D model for the target garment. The draped target garment 304 replaces the removed piece of garment from the image 302 on the 3D model. Garments may vary in their opacity, texture, and movement. For example, some materials provide a semi-transparent garment. In some embodiments, a blending mask is applied to the draped target garment 304, accounting for opacity of the target garment and ensuring aspects of the level of transparency in the garment is projected onto the 3D model. In some implementations, the blending mask may include an opacity map. In some implementations, the opacity map may be generated by the refinement network 202 to produce a final output.

According to embodiments, the 3D model is fitted to the segmented image 308 to extend (or remove) the consumer limbs 310-1 and 310-2 (hereafter collectively referred to as “consumer limbs 310”) according to the target garment. This enables proper representation of different types of clothing (e.g., a long-sleeved shirt vs. a short-sleeved shirt, which expose parts of the body/limbs differently). The prediction image 306 is a 2D projection of the combination of the pieces obtained in the segmented image 308, draped target garment 304, and consumer limbs 310 stages.

According to embodiments, a ground truth image 312-1 and 312-2 (hereafter collectively referred to as “ground truth image 312”) may be used to evaluate a loss function with the prediction image 306 by comparing a final rendering of the VTO application 200 with the ground truth image 312. The loss function is used to improve the VTO application 200 performance.

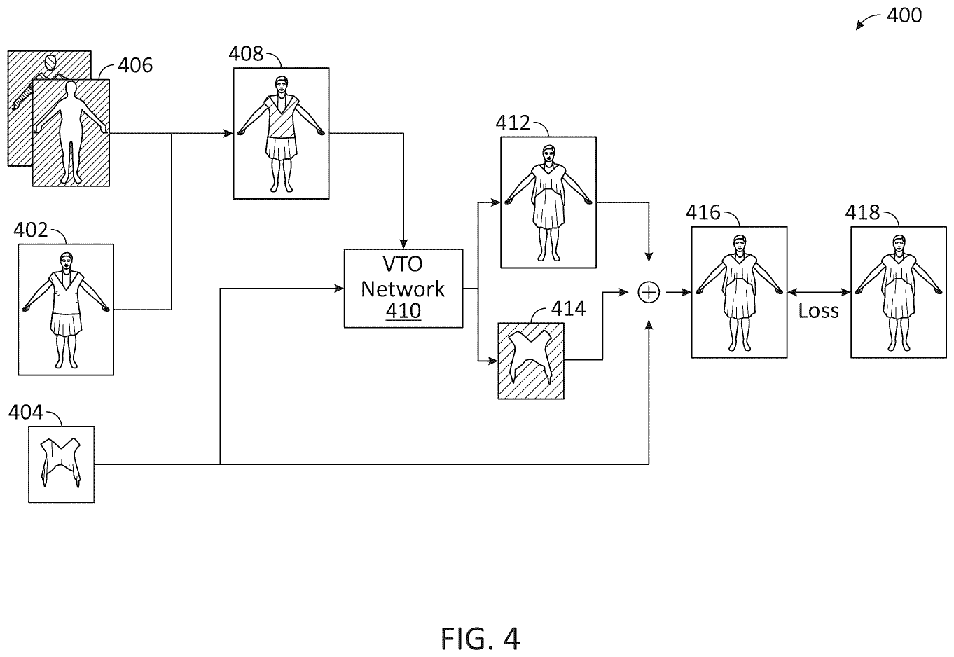

FIG. 4 illustrates a schematic of a process in a VTO system 400 used for rendering a 2D image of a 3D physical model of a consumer wearing a target garment using a VTO model, according to some embodiments. The VTO model achieves this with a 3D model of a body, a 3D model of a garment, and a reference image of a consumer.

As shown in FIG. 4, a consumer provides an input image 402 wearing random clothes. In some embodiments, the input image 402 is a self-image collected by a user (e.g., the consumer) with a client device (e.g., a personal mobile phone). A target garment may be selected by the consumer in the VTO application, for example, via the client device. A 3D garment model 404 is identified based on the target garment selection. The 3D garment model 404 may include information indicating physical properties and/or attributes of the target garment (e.g., color, textures, etc.). In some embodiments, the 3D garment model 404 is retrieved from 3D models corresponding to a set of selectable garments stored in, for example, a server of the VTO application. In some embodiments, the 3D garment model 404 is retrieved from a retailer or brand database associated with the VTO application. A 3D model 406 of the consumer may be generated based on one or more sources including, but not limited to, external sources, images of the consumer (e.g., from the client device), a scan, or the like. In some embodiments, the 3D model 406 of the consumer may be extracted from the input image 402. In some embodiments, the 3D model 406 captures a consumer pose based on the input image 402 and a known orientation of the camera.

Given the 3D model 406 of the consumer and the consumer image 402, an existing garment on the consumer in the input image 402 is masked out. The masked-out garment is identified based on the target garment and removed using, for example, segmentation maps. In the example of FIG. 4, the target garment is a top/shirt. Accordingly, a top garment (to be replaced by the target garment) is masked in the consumer image 402, generating a masked image 408. The masked image 408 and a target garment projection, based on the 3D garment model 404, are fed into a VTO network 410.

According to embodiments, the VTO network 410 drapes the target garment on the masked image 408 to generate an initial render 412 of the consumer wearing the target garment. The VTO network 410 also generates a composition map 414. Given the consumer image 402 is used at least in part to generate the initial render 412, it accurately reflects aspects of the consumer image 402. By non-limiting example, the initial render 412 includes from the consumer image 402 a same pose, background (e.g., indicative of a location or environment of the consumer), coloring, lighting, or the like.

According to embodiments, the VTO model is trained to capture avatar texture, garments, and backgrounds, with few artifacts. In some embodiments, the VTO model may identify a light source from the input image 402, and use the light source for relighting the draped avatar accordingly.

The initial render 412 is further adjusted using the composition map 414 and the 3D garment model 404. The 3D garment model 404 may be analyzed and used to adjust including, but not limited to, adding the physical attributes of the 3D garment model 404 to generate a final render 416. This may improve the framing, placement, structure, and overall visual components of the draped garment in the final render 416, ensuring an accurate fit in the final render 416. The final render 416 may be a 2D image of a 3D physical model of the consumer wearing the target.

According to embodiments, the composition map 414 may refine compositions as post-processing on the image. The composition map 414 may include, but is not limited to, applying blending masks, adjustments to a fit and contouring based on the 3D model 406 of the consumer, color and opacity adjustments, or the like. Accordingly, the final render 416 looks like it was taken as a photo of the consumer wearing the target garment.

According to embodiments, the final render 416 is compared with a ground-truth image 418 for evaluating a loss function (e.g., using key points in the target garment area). The loss function may include perceptual losses between the final render 416 and the ground truth image 418 including, for example, creases, shades, and stretching of the target garment over the consumer's body.

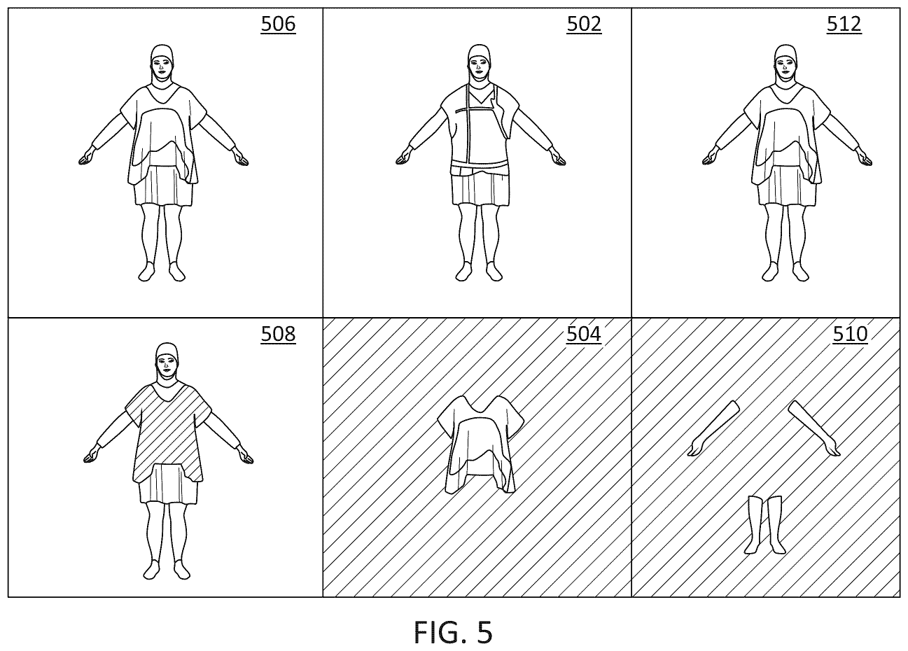

FIG. 5 illustrates another example with a 2D projection of a 3D model wearing a digital garment selected by an online shopper from a catalog according to the VTO system 400 described in FIG. 4.

The consumer provides an input image (2D) 502 wearing random clothes and enters a target online garment for try on. The system 400 may retrieve a 3D avatar for the online shopper and superimpose the input image 502 to the 3D avatar. At least one or more of the random clothes in the input image 502 will be replaced, or overlayed, by the target garment.

A preserve image 508 is generated comprising the input image with an original garment area masked out. The original garment area may correspond to an area identified based on the target garment. In some embodiments, the system 400 may perform a segmentation step to remove a piece of clothing that will be replaced by the target garment to generate the preserve image 508. The segmentation step may include segmenting the consumer's limbs 510 and secondary garments in the input image 502 which will be used in a final rendering (e.g., 2D image projection 506). The secondary garment may be any other garments or clothing identified in the input image 502 (e.g., worn by the consumer) which the target garment does not replace (e.g., the lower garment in the input image 502). In some embodiments, the limbs 510 may indicate limb masks (e.g., arms and legs) to assist the VTO network 410 with rare or unusual poses. In some embodiments, the secondary garment in the input image 502 may interact with the target garment based on a physical attribute of the target garment, a predicted physical attribute of the secondary garment, and the 3D model of the consumer.

In some embodiments, to patch any leftover or secondary garments or clothing from the input image 502, the VTO model paints a first portion of the first garment that overlaps the body of the online shopper, and a second portion of a first clothing in the input image that overlaps the target garment.

According to embodiment, a draping image 504 includes the target garment draped onto the same pose, shape, structural features that the consumer strikes in the input image 502. The draping image 504 is projected on the preserve image 508. According to embodiments, the target garment may be draped on the masked area of the preserve image 508 (e.g., on a top garment worn by the consumer in the input image). In some embodiments, the system 400 overlays the 3D model of the garment on the segmented image on a 3D model of the consumer to complete a fully dressed avatar.

The system 400 generates a 2D image projection 506 of the fully dressed avatar. According to embodiments, the 2D image projections of the system may be improved based on a ground truth image. In some embodiments, a ground truth image 512 may be a real image of the consumer wearing the target garment. In some embodiments, the ground truth image may be synthetically generated by some iteration of the VTO model described herein. In some embodiments, the ground truth image 512 may be used to evaluate a loss function and train the VTO model. In some embodiments, the ground truth image 512 may be a 2D projection of the dressed avatar used in an iterative process.

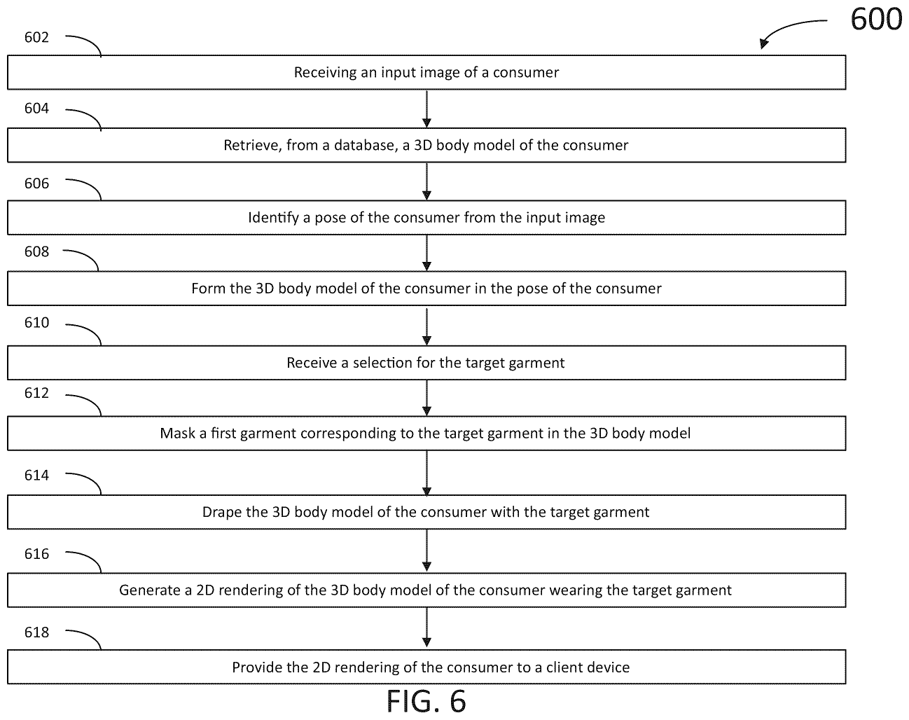

FIG. 6 is a flowchart illustrating steps in a method 600 for providing an accurate 2D image of a 3D model in a target garment and fit to a consumer, according to some embodiments. The consumer may be an online shopper, and the target garment may be chosen by the consumer from an online retail or brand manufacturer catalogue. In some embodiments, at least one step in method 600 may be executed by a processor circuit reading instructions from a memory circuit. The processor circuit and the memory circuit may be in a VR headset, a remote server, a mobile phone, or a database, as disclosed herein. The VR headset, remote server, mobile phone, and database may be communicatively coupled via a network, by a communications module. In some embodiments, methods consistent with the present disclosure may include at least one or more of the steps in method 600 performed in a different order, simultaneously, quasi-simultaneously, or overlapping in time.

Step 602 includes receiving an input image of a consumer. In some embodiments, step 602 includes receiving a self-image from a client device with the consumer, via a network (e.g., network 150).

Step 604 includes retrieving, from a database (e.g., database 152), a 3D body model of the consumer and forming the 3D model based on the input image. In some embodiments, step 604 includes retrieving tailor measurements of the consumer and multiple images of the consumer, to form the 3D body model of the consumer.

Step 606 includes identifying a pose of the consumer from the input image. In some embodiments, step 606 includes identifying a direction of view of the input image from an inertial measurement unit in a mobile device used to collect the input image.

Step 608 includes forming the 3D body model of the consumer in the pose of the consumer (identified in step 606). The 3D body model may appear like the consumer in the input image, for example, having the same pose, clothes, background/environment, etc.

Step 610 includes receiving a selection for a target garment. The target garment may be selected, at the client device, by the consumer from a set of available options on, for example, an online retail or brand manufacturer catalogue. In some embodiments, step 610 further includes retrieving a 3D model of the target garment from a database/server based on the selection. In some implementations, the target garment may include one or more garments.

Step 612 includes masking a first garment in the input image. A position of the first garment may correspond to an intended position of the target garment based on the 3D model of the target garment. In some embodiments, step 612 includes identifying clothing worn by the consumer in the input image and determining the first garment corresponding to the target garment. In some embodiments, step 612 includes masking the first garment from the input image to form a preserved image (with the first garment removed), and segmenting the 3D body model of the consumer to fit the preserved image and the 3D model of the target garment.

Step 614 includes draping the 3D body model of the consumer with the target garment based on the 3D model of the target garment, resulting in a 3D model of the consumer wearing the target garment. According to embodiments, the clothing worn by the consumer in the input image may comprise a second garment including one or more articles of clothing worn by the consumer, excluding the first garment. Step 614 may include identifying the second garment, and draping the 3D body model of the consumer with the second garment in addition to the target garment, thus replacing the first garment only and retaining all other aspects of the input image (e.g., background, other clothing, lighting, pose, etc.). By non-limiting example, the target garment may be a skirt selected for try-on by the consumer. The consumer may be wearing shorts and a shirt in the input image. In this example, the first garment would correspond to the shorts, as they will be replaced with the skirt, and the shirt would correspond to the second garment which will be draped on the 3D body model along with the skirt (i.e., target garment).

In some embodiments, step 614 includes deforming the 3D model of the target garment according to a physical attribute of the target garment and a geometry of the 3D body model of the consumer. In some embodiments, step 614 includes interacting the second garment with the target garment based on a physical attribute of the target garment, a predicted physical attribute of the second garment, and the 3D body model of the consumer. The method 600 may include analyzing the image to determine the predicted physical attribute of the second garment and one or more parameters of the second garment that would interact or otherwise effect the target garment. This accounts for any effects of the second garment on the fit of the target garment on the user (e.g., some shirts may be bulkier, causing a jacket to appear more fitted when worn). In this manner, the target garment is draped on the 3D model to fit according to the target garment and any other garments the user is wearing.

In some embodiments, step 614 includes relighting the 3D body model of the consumer based on the input image. In some embodiments, relighting includes identifying an illumination source from the input image and using the illumination source to relight the 3D body model of the consumer with the target garment. In some embodiments, step 614 includes inpainting a first portion of the first garment that overlaps the 3D body model of the consumer, and a second portion of the first garment that overlaps the target garment.

Step 616 includes generating a 2D rendering of the 3D body model of the consumer wearing the target garment. Step 618 includes providing the 2D rendering of the 3D body model of the consumer wearing the target garment to the client device. In some embodiments, step 618 includes providing the 2D rendering to a display in the client device including a 2D pixel array configured to display a 2D image.

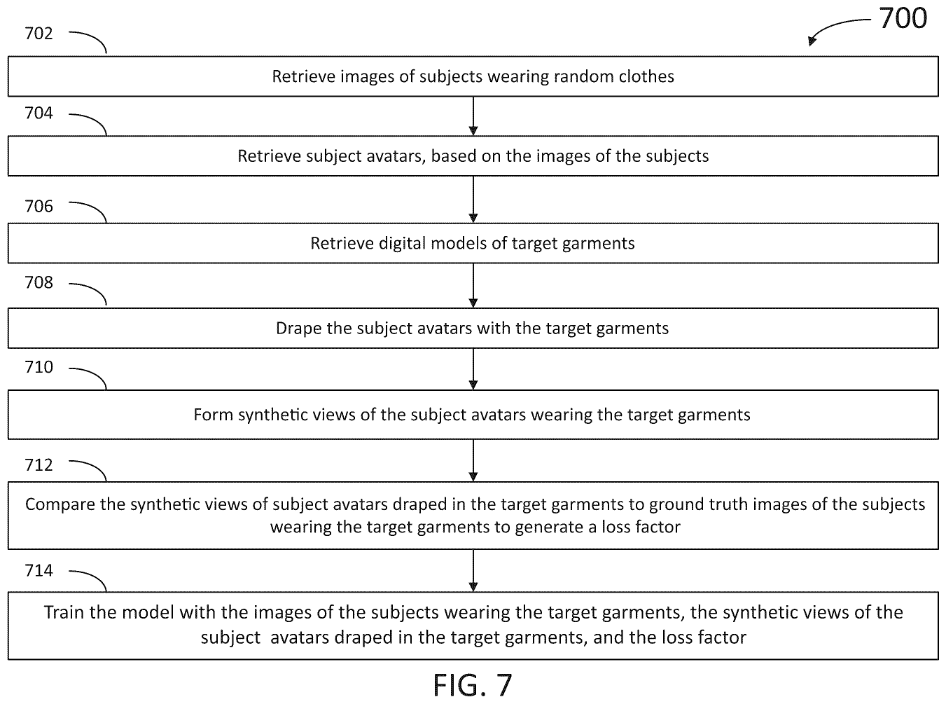

FIG. 7 is a flowchart illustrating steps in a method 700 for training a VTO model, according to some embodiments. One or more steps in the method 700 may be repeated to guide the optimization of the VTO model and improve renderings output by the VTO model. In some embodiments, at least one step in method 700 may be executed by a processor circuit reading instructions from a memory circuit. The processor circuit and the memory circuit may be in a VR headset, a remote server, a mobile phone, or a database, as disclosed herein. The VR headset, remote server, mobile phone, and database may be communicatively coupled via a network, by a communications module. In some embodiments, methods consistent with the present disclosure may include at least one or more of the steps in method 700 performed in a different order, simultaneously, quasi-simultaneously, or overlapping in time.

Step 702 includes retrieving images of subjects wearing random clothes.

Step 704 includes retrieving subject avatars, based on the images of the subjects.

Step 706 includes retrieving digital models of target garments.

Step 708 includes draping the subject avatars with the target garments. In some embodiments, step 708 includes removing at least one of the random clothes from 3D models of the subjects, to form segmented models and replacing the random clothes with the digital models of the target garments to create full body models of the subjects wearing the target garments. Step 710 includes forming synthetic views of the subject avatars wearing the target garments.

Step 712 includes comparing the synthetic views of subject avatars draped in the target garments to ground truth images of the subjects wearing the target garments to generate a loss factor. In some embodiments, step 712 includes selecting multiple key points in each of the images of the subject and each of the synthetic views of the subject for evaluating a loss function.

Step 714 includes training the model with images of subjects wearing the target garments, the synthetic views of the subject avatars draped in the target garments, and the loss factor. In some embodiments, step 714 includes using the synthetic view of a first subject wearing a first target garment as the image of the subject wearing random clothes in a further training iteration. In some embodiments, step 714 includes adjusting a coefficient in a neural network when a value of the loss function is greater than a preset threshold.

### Hardware Overview

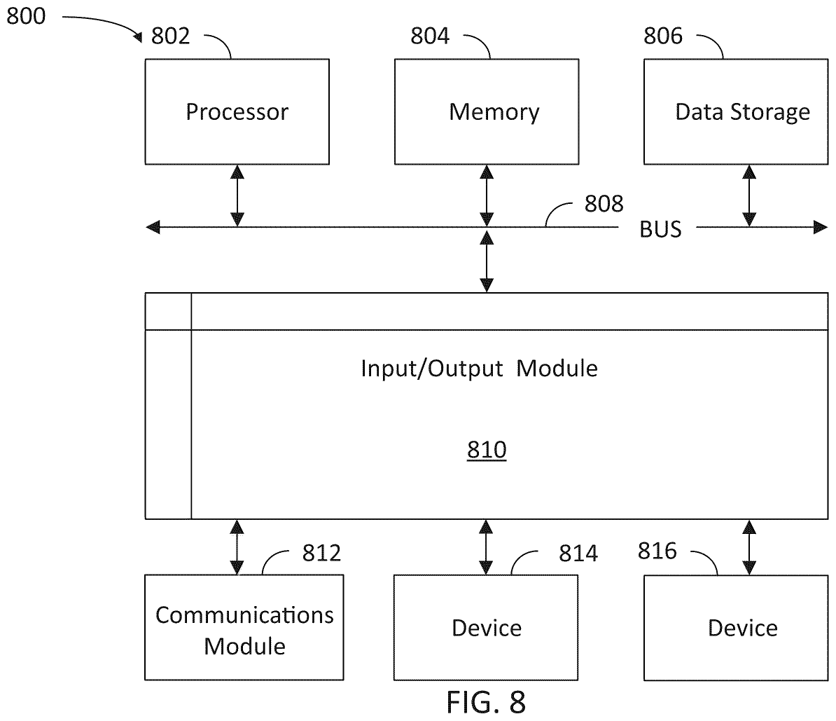

FIG. 8 is a block diagram illustrating an exemplary computer system 800 with which aspects of the subject technology can be implemented. In certain aspects, the computer system 800 may be implemented using hardware or a combination of software and hardware, either in a dedicated server, integrated into another entity, or distributed across multiple entities.

The computer system 800 (e.g., server 130 and/or mobile device 110) includes a bus 808 or other communication mechanism for communicating information, and a processor 802 coupled with the bus 808 for processing information. By way of example, the computer system 800 may be implemented with one or more processors 802. Each of the one or more processors 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

The computer system 800 can include, in addition to hardware, code that creates an execution environment for the computer program in question, e.g., code that constitutes processor firmware, a protocol stack, a database management system, an operating system, or a combination of one or more of them stored in an included memory 804, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 808 for storing information and instructions to be executed by processor 802. Processor 802 and memory 804 can be supplemented by, or incorporated in, special purpose logic circuitry.

The instructions may be stored in memory 804 and implemented in one or more computer program products, i.e., one or more modules of computer program instructions encoded on a computer-readable medium for execution by, or to control the operation of, the computer system 800, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 804 may also be used for storing temporary variable or other intermediate information during execution of instructions to be executed by the processor 802.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

The computer system 800 further includes a data storage device 806 such as a magnetic disk or optical disk, coupled to bus 808 for storing information and instructions. The computer system 800 may be coupled via input/output module 810 to various devices. The input/output module 810 can be any input/output module. Exemplary input/output modules 810 include data ports such as USB ports. The input/output module 810 is configured to connect to a communications module 812. Exemplary communications modules 812 include networking interface cards, such as Ethernet cards and modems. In certain aspects, the input/output module 810 is configured to connect to a plurality of devices, such as an input device 814 and/or an output device 816. Exemplary input devices 814 include a keyboard and a pointing device, e.g., a mouse or a trackball, by which a user can provide input to the computer system 800. Other kinds of input devices can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 816 include display devices such as an LCD (liquid crystal display) monitor, for displaying information to the user.

According to one aspect of the present disclosure, the above-described systems can be implemented using a computer system 800 in response to the processor 802 executing one or more sequences of one or more instructions contained in the memory 804. Such instructions may be read into memory 804 from another machine-readable medium, such as data storage device 806. Execution of the sequences of instructions contained in the main memory 804 causes the processor 802 to perform the process steps described herein. One or more processors in a multi-processing arrangement may also be employed to execute the sequences of instructions contained in the memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

The computer system 800 can include clients and servers. A client and server are generally remote from each other and typically interact through a communication network. The relationship of client and server arises by virtue of computer programs running on the respective computers and having a client-server relationship to each other. The computer system 800 can be, for example, and without limitation, a desktop computer, laptop computer, or tablet computer. The computer system 800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to the processor 802 for execution. Such a medium may take many forms, including, but not limited to, non-volatile media, volatile media, and transmission media. Non-volatile media include, for example, optical or magnetic disks, such as the data storage device 806. Volatile media include dynamic memory, such as the memory 804. Transmission media include coaxial cables, copper wire, and fiber optics, including the wires that comprise the bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A computer-implemented method for garment virtual try-ons, the method comprising:
receiving, at a client device, an input image of a consumer;
generating a 3D body model of the consumer;
receiving a selection, from the consumer, of a target garment;
generating a masked image by masking a first garment from the input image;
segmenting the 3D body model of the consumer to fit the masked image and a 3D garment model of the target garment;
draping the 3D body model of the consumer with the target garment; and
providing, to the client device, a try-on image of the consumer including the target garment.

2. The computer-implemented method of claim 1, further comprising:
identifying a pose of the consumer in the input image; and
forming the 3D body model of the consumer in the pose of the consumer.

3. The computer-implemented method of claim 1, further comprising retrieving, from a first database, the 3D body model of the consumer.

4. The computer-implemented method of claim 1, further comprising retrieving, from a second database, the 3D garment model of the target garment.

5. The computer-implemented method of claim 1, further comprising generating the try-on image as a 2D rendering of the 3D body model of the consumer wearing the target garment.

6. The computer-implemented method of claim 1, wherein the input image is a self-image of the consumer.

7. The computer-implemented method of claim 1, further comprising identifying a direction of view of the input image from an inertial measurement unit in the client device.

8. The computer-implemented method of claim 1, wherein draping the 3D body model of the consumer with the target garment includes deforming the 3D garment model according to a physical attribute of the target garment and a geometry of the 3D body model of the consumer.

9. The computer-implemented method of claim 1, further comprising interacting a second garment with the target garment based on a physical attribute of the target garment, a predicted physical attribute of the second garment, and the 3D body model of the consumer.

10. The computer-implemented method of claim 1, further comprising:
identifying the first garment and a second garment in the input image, wherein the consumer is wearing the first garment and the second garment, and a position of the first garment on the 3D body model corresponding to an intended position of the target garment based on the 3D garment model;
removing the first garment from the input image to form the masked image; and
draping the 3D body model of the consumer with the target garment and the second garment.

11. The computer-implemented method of claim 10, wherein the second garment includes one or more articles of clothing worn by the consumer in the input image excluding the first garment.

12. A system for garment virtual try-ons, comprising:
one or more processors; and
a memory comprising instructions stored thereon, which when executed by the one or more processors, causes the one or more processors to perform:
receiving, at a client device, an input image of a consumer;
generating a 3D body model of the consumer;
receiving a selection, from the consumer, of a target garment;
generating a masked image by masking a first garment from the input image having a position corresponding to an intended position of the target garment based on a 3D garment model of the target garment;
segmenting the 3D body model of the consumer to fit the masked image and the 3D garment model of the target garment;
draping the 3D body model of the consumer with the target garment; and
providing, to the client device, a try-on image of the consumer including the target garment.

13. The system of claim 12, wherein the instructions, when executed by the one or more processors, cause the one or more processors to perform:
identifying a pose of the consumer in the input image; and
forming the 3D body model of the consumer in the pose of the consumer.

14. The system of claim 12, wherein the instructions, when executed by the one or more processors, cause the one or more processors to perform:
retrieving, from a first database, the 3D body model of the consumer; and
retrieving, from a second database, the 3D garment model of the target garment.

15. The system of claim 12, wherein the instructions, when executed by the one or more processors, cause the one or more processors to perform:
generating the try-on image as a 2D rendering of the 3D body model of the consumer wearing the target garment.

16. The system of claim 12, wherein the instructions, when executed by the one or more processors, cause the one or more processors to perform identifying a direction of view of the input image from an inertial measurement unit in the client device.

17. The system of claim 12, wherein the instructions, when executed by the one or more processors, cause the one or more processors to perform draping the 3D body model of the consumer with the target garment includes deforming the 3D garment model according to a physical attribute of the target garment and a geometry of the 3D body model of the consumer.

18. The system of claim 12, wherein the instructions, when executed by the one or more processors, cause the one or more processors to perform interacting a second garment with the target garment based on a physical attribute of the target garment, a predicted physical attribute of the second garment, and the 3D body model of the consumer.

19. The system of claim 12, wherein the instructions, when executed by the one or more processors, cause the one or more processors to perform:
identifying the first garment and a second garment in the input image, the second garment including one or more articles of clothing worn by the consumer in the input image, excluding the first garment;
removing the first garment from the input image to form the masked image; and
draping the 3D body model of the consumer with the target garment and the second garment.

20. A non-transitory computer-readable storage medium comprising instructions stored thereon, which when executed by one or more processors, cause the one or more processors to perform operations for garment virtual try-ons, comprising:
receiving, at a client device, an input image of a consumer;
generating a 3D body model of the consumer;
receiving a selection, from the consumer, of a target garment;
generating a masked image by masking a first garment from the input image having a position corresponding to an intended position of the target garment based on a 3D garment model of the target garment;
segmenting the 3D body model of the consumer to fit the masked image and the 3D garment model of the target garment;
draping the 3D body model of the consumer with the target garment; and
providing, to the client device, a try-on image of the consumer in the target garment.
